(19) United States
(12) Patent Application Publication
(10) Pub. No.: US 2018/0050502 A1
(43) Pub. Date: Feb. 22, 2018

(54) FIBER PLACEMENT HEAD WITH SECONDARY COMPACTION ARRANGEMENT

(71) Applicant: Lodovico E. Oldani, Rockford, IL (US)

(72) Inventor: Lodovico E. Oldani, Rockford, IL (US)

(73) Assignee: Ingersoll Machine Tools, Inc., Rockford, IL (US)

(21) Appl. No.: 15/639,944

(22) Filed: Jun. 30, 2017

Related U.S. Application Data
(60) Provisional application No. 62/377,394, filed on Aug. 19, 2016.

(51) Int. Cl. B29C 70/38; B29C 70/34; B29C 70/54; B29C 70/16

(52) U.S. Cl. CPC B29C 70/384; B29C 70/34; B29K 2063/00; B29C 70/16; B29C 70/54

(57) ABSTRACT

A fiber placement head with secondary compaction arrangement is provided. The fiber placement head includes a frame, at least one heating module mounted to the frame, and a primary compaction roller mounted to the frame. The secondary compaction arrangement includes a secondary idle compacting roller, operating after the primary compacting roller, performing a post retracing on the tows just applied by the primary compaction roller. The secondary compaction arrangement may also include an additional (secondary) heating module interposed between the primary and secondary compaction rollers. Re-heating and re-pressing the tows addresses those tows which are insufficiently bonded to a working surface due to the tow being insufficiently tacky.

### CROSS-REFERENCE TO RELATED PATENT APPLICATIONS

This patent application claims the benefit of U.S. Provisional Patent Application No. 62/377,394, filed Aug. 19, 2016, the entire teachings and disclosure of which are incorporated herein by reference thereto.

### FIELD OF THE INVENTION

This invention relates to the forming of composite structures with automated fiber placement machines, and more particularly to the fiber placement head of such fiber placement machines.

### BACKGROUND OF THE INVENTION

Automated fiber placement machines are widely used to manufacture parts, components and structures from composite material. These systems typically comprise a fiber placement head or heads spatially positionable by multiaxis positioners. The fiber placement head is operable to lay up carbon fiber composite tows and/or tape onto a stationary mold, i.e. tool.

The materials used in automated fiber placement heads are typically engineered for lay-up epoxy matrix materials such as unidirectional carbon fibers pre-impregnated into a resin and are provided as tapes, or thin strips, commonly known as “tows.” The term “tows” is used herein to collectively refer to tows, tapes, or plys thereof.

Each head is usually capable of laying and compacting a plurality of tows arranged side-by-side to form a “ply” or “course” over and onto a tool. The fiber placement head usually has all means to lay-up the tows automatically such as a compaction roller, means to individually cut or add each tow whenever required as well as means to heat up the tows and/or the substrate zone to ensure sufficient tack for tow adhesion.

In an exemplary known configuration, the fiber placement head includes a compaction roller for pressing (“laying up”) the tows against the surface of the mold or the preceding layers of material forming the composite part (collectively the “working surface”). Such compaction is done in an effort to ensure proper placement and fixation of the tow.

The fiber placement head is also automatically fed by an integrated tow magazine (creel) which supplies the tow in an organized array and with a correct tension and temperature. This tow magazine system and fiber placement head are mounted at the ram end of the multiaxis positioner which under instructions provided by suitable control means is capable of following a desired multiple-pass lay-up path onto a stationary mold which remains stationary and is anchored to the ground. Alternatively, it is also possible to maintain the fiber placement head generally stationary, and move the mold relative thereto.

The majority of fiber placement heads are optimized for the lay-up of graphite fibers and epoxy embedded in a thermosetting plastic matrix and they have been capable, over the years, to reach a good quality and impressive production rate in terms of pound/hr. Unfortunately, modern aerospace structures are more often requiring tows made of a substantially different material such as bismaleimide (BMI) matrix materials, which can endure higher temperatures and have been selected for the next generation of composite aircraft components.

In their original forms, the fiber placement heads and processes in question are not optimum for manufacture of BMI-matrix materials, which, in comparison to epoxies, present greater difficulty in processing.

As a result of the greater difficulties, deposition rates for BMI-matrix composites have been far lower than those for epoxy-matrix composites. It is therefore paramount to find improvements capable to achieve deposition rates for BMI-matrix materials comparable to the ones presently achievable with epoxy-matrix composites.

The main material/processing known issues to be addressed in order to achieve the desired improvements are the insufficient tackiness of the BMI-matrix material versus epoxy-matrix and the buildup of resin and fiber fuzz which creates frequent clogging of processing equipment, the first being by far the most challenging.

Attempts to improve the tackiness issue, based on controlling humidity and temperature are known. Tackiness increases with humidity, making it desirable to process at the highest possible humidity that can be used without adversely affecting other aspects of processing.

There have also been attempts to increase the heating module of the fiber placement head to enable heating to a higher temperature in the area right before the main compaction point. The most popular means to provide heat in fiber placement heads is via radiant heat transfer using infrared heating modules (i.e IR heaters). In particular, it is not uncommon to arrange an IR heater just upstream from the aforementioned compaction roller relative to the lay-up direction (i.e. the direction the fiber placement head moves to apply the tows).

This IR heater is responsible for pre-heating the working surface. This ensures that the tows, when contacting this heated working surface, will properly adhere. In operation, the working surface is first heated as the fiber placement head moves in the lay-up direction, the tow(s) is then immediately deposited unto the heated working surface as the fiber placement head continues to move in the lay-up direction, and then immediately compacted by the aforementioned compaction roller as the fiber placement head continues to move in the lay-up direction.

Even with such IR heaters, excessive heat is necessary when utilizing tows with BMI matrix. In this regard, the improvements have been modest because excessive heat gives rise to other critical limitations. As a result, tows with BMI matrix materials with poor tackiness, can nowadays be processed by conventional fiber placement head operating though at a substantially lower feed rates in order to obtain an acceptable process quality.

Accordingly, there is a need in the art for a fiber placement head that is engineered and optimized for BMI-matrix materials which is capable of significantly increasing the feed rates of such materials from what is now presently obtainable. The invention provides such a fiber placement head and associated componentry. These and other advantages of the invention, as well as additional inventive features, will be apparent from the description of the invention provided herein.

### BRIEF SUMMARY OF THE INVENTION

In one aspect, the invention provides a fiber placement head with significant improvement in tow lay-up fidelity. An embodiment of such a fiber placement head is movable in a lay-up direction to deposit one or more tows on a working surface. The fiber placement head includes a frame. The fiber placement head also includes a primary compaction roller mounted to the frame and configured to apply a downward compaction force against the one or more tows upon being deposited on the working surface. The fiber placement head also includes at least one primary heating module mounted to the frame upstream from the primary compaction roller relative to the lay-up direction. The fiber placement head also includes a secondary compaction arrangement mounted to the frame downstream from the primary compaction roller relative to the lay-up direction.

The secondary compaction arrangement includes a support frame mounted to the frame of the fiber placement head. The secondary compaction arrangement also includes a secondary compaction roller mounted to the support frame and configured to apply a downward force against the one or more tows subsequent to compaction by the primary compaction roller. The secondary compaction arrangement can also include at least one secondary heating module mounted to the support frame. In certain embodiments according to this aspect, at least one of the primary compaction roller and secondary compaction roller is a compliant compaction roller.

In certain embodiments according to this aspect, the at least one primary heating module includes multiple heating modules. The at least one primary heating module may be an IR heater. The at least one secondary heating module may also be an IR heater. In one arrangement, the at least one secondary heating module is interposed between the primary compaction roller and the secondary compaction roller relative to the lay-up direction.

In another aspect, the invention provides a secondary compaction roller arrangement such a secondary compaction arrangement may be readily retrofit unto an existing fiber placement head. The fiber placement head being movable in a lay-up direction to deposit one or more tows on a working surface and comprising a frame, a primary compaction roller mounted to the frame, and at least one primary heating module mounted to the frame.

An embodiment of a secondary compaction arrangement according to this aspect includes a support frame configured for mounting to the frame of the fiber placement head. The secondary compaction arrangement also includes a secondary compaction roller mounted to the support frame and configured to apply a downward force against the one or more tows. The secondary compaction roller is arranged downstream from the primary compaction roller relative to the lay-up direction.

The secondary compaction arrangement may also include at least one secondary heating module mounted to the support frame. The at least one secondary heating module arranged upstream from the secondary compaction roller relative to the lay-up direction.

In an exemplary embodiment, the support frame includes a base member and a pair of intermediate members mounted in parallel relative to one another to the base member. The base member comprises first end regions configured for mounting the support frame to the frame of the fiber placement head. Each intermediate member comprises a actuating member. The support frame also includes a mounting member, the mounting member mounted to the actuating members. Each actuating member is connected to the base member at a respective first end of each intermediate member, and the mounting member is mounted at a respective second end of each actuating member which is opposite the first end.

The secondary compaction arrangement also includes a roller base mounted to the mounting member. The secondary compaction roller is rotatably mounted to said roller base. The at least one secondary heater is also mounted to the mounting member. In certain embodiments, the secondary compaction roller may be a compliant compaction roller.

In yet another aspect, the invention provides a method for laying up one or more tows on a working surface using a fiber placement head with increased tow adhesion fidelity. An embodiment of a method according to this aspect includes preheating a working surface using at least one primary heating module, depositing one or more tows on the preheated working surface, compacting the one or more tows using a primary compaction roller, and compacting the one or more tows again using a secondary compaction roller after being compacted by the first compaction roller.

This method may also include heating the one or more tows with at least one secondary heater after being compacted by the first compaction roller.

In certain embodiments according to this aspect, compacting the one or more tows again using the secondary compaction roller after being heated by the at least one secondary heater includes compacting said tows using a compliant compaction roller.

In certain embodiments according to this aspect, heating the one or more tows after being compacted by the primary compaction roller using at least one secondary heating module includes using an IR heater as the at least one secondary heating module.

Other aspects, objectives and advantages of the invention will become more apparent from the following detailed description when taken in conjunction with the accompanying drawings.

### BRIEF DESCRIPTION OF THE DRAWINGS

The accompanying drawings incorporated in and forming a part of the specification illustrate several aspects of the present invention and, together with the description, serve to explain the principles of the invention. In the drawings:

FIG. 1 is a side view of an exemplary embodiment of a fiber placement head with secondary compaction arrangement according to the teachings herein;

FIG. 2 is side view of an exemplary embodiment of the secondary compaction arrangement of FIG. 1;

FIG. 3 is a perspective view of the fiber placement head of FIG. 1; and

FIG. 4 is a perspective view of the secondary compaction arrangement of FIG. 2.

While the invention will be described in connection with certain preferred embodiments, there is no intent to limit it to those embodiments. On the contrary, the intent is to cover all alternatives, modifications and equivalents as included within the spirit and scope of the invention as defined by the appended claims.

### DETAILED DESCRIPTION OF THE INVENTION

Turning now to the exemplary embodiment shown in the figures, the same provides for a secondary compaction arrangement incorporated into a fiber placement head. This secondary compaction arrangement includes a secondary compaction roller, which is downstream from a primary compaction roller of the fiber placement head relative to a lay-up direction of the fiber placement head.

This secondary compaction roller advantageously provides for an additional compaction of the one or more tows being applied by the fiber placement head. Such a configuration advantageously ensures proper adhesion of the tows, particularly tows including a BMI matrix. Such a system provides a very effective and advantageous solution for improving quality of the layup. Such a system advantageously also allows for process feed rates for lay-up operations using BMI matrix materials to approach those presently achievable with epoxy matrix materials. Even more broadly, the system described herein advantageously provides a solution for poorly adhering composite materials (not necessarily only BMI matrix materials) used in fiber placement operations. Extensive testing by the Applicant has proven a performance gap exceeding expectations.

While not a requirement, the secondary compaction arrangement may also include at least one secondary heating module. Such a secondary heating module may be interposed between the primary and secondary compaction rollers, and provides for additional heating of the tows after being initially compacted by the primary compaction roller, and prior to being compacted by the secondary compaction roller.

As used herein, the terms “upstream” and “downstream” are used relative to the lay-up direction. A first component is said to be “upstream” from a second component relative to the lay-up direction where the first component is ahead of the second component relative to the lay-up direction as the fiber placement head moves in the lay-up direction. Likewise, a first component is said to be “downstream” from a second component where the first component is behind the second component relative to the lay-up direction as the fiber placement head moves in the lay-up direction. “First” and “second” are used in the preceding only for purposes of exemplary differentiation.

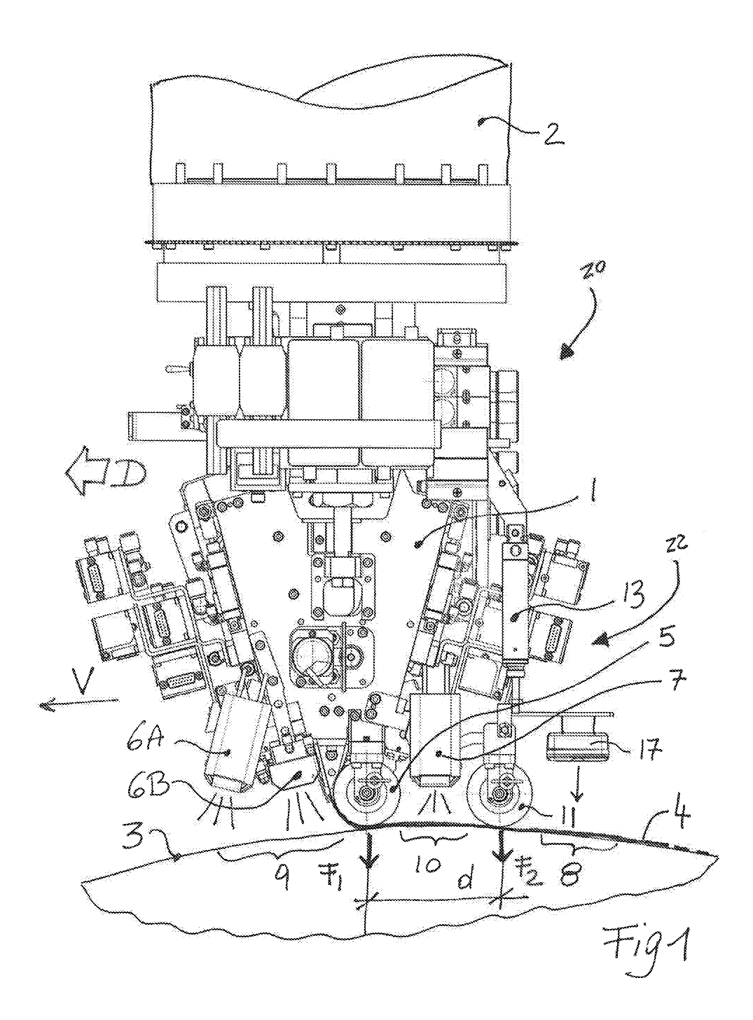

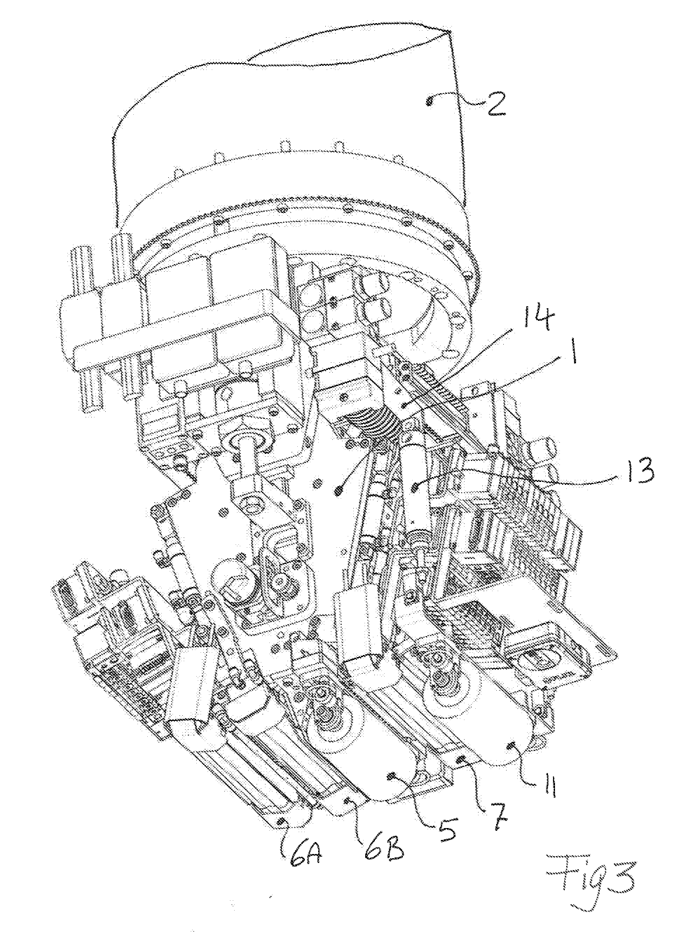

With particular reference now to FIG. 1, an exemplary embodiment of a fiber placement head 20 equipped with a secondary compaction arrangement 22 according to the teachings herein is illustrated. Fiber placement head 20 is mounted on the end of a multiple axes positioner ram 2 and is operable for laying up a plurality of tows onto the stationary working surface 3 of a mold. Fiber placement head 20 is also illustrated in FIG. 3 in a perspective 3 for additional clarity.

Fiber placement head 20 includes a frame 1 and internal componentry for advancing one or more tows from a creel (not shown) onto working surface 3. Fiber placement head 20 is equipped with at least one primary heating module, in this case, a double module unit including heaters 6a and 6b, which respectively provide heating power to the area/zone 9, immediately upstream from a primary compaction roller 5. Some of this heating power is also delivered to the tows 4 being laid.

It will be recognized that, with the exception of the additional components described in detail herein, fiber placement head 20 may take the form of any fiber placement head. As one non-limiting example, 20 may incorporate some or all of the structure and/or functionality as that disclosed in U.S. Pat. No. 7,731,816 to Oldani filed on Feb. 15, 2007, titled, “SYSTEM AND METHOD FOR HEATING CARBON FIBER USING INFRARED RADIATION IN A FIBER PLACEMENT MACHINE” assigned to the instant Assignee, the teachings and disclosure of which is incorporated herein by reference thereto.

As can be seen in U.S. Pat. No. 7,731,816, such an exemplary embodiment of a contemporary fiber placement head typically includes a frame, a compaction roller mounted to the frame, and at least one primary heating module. Indeed, it is contemplated by the invention herein that the same may be embodied as a stand alone fiber placement head which includes a secondary compaction arrangement 22 as set forth in the following, or alternatively, embodied as an add-on secondary compaction arrangement which may be readily retro-fit onto an existing fiber placement head.

Fiber placement head 20 is movable along a lay-up direction D at a given feed rate speed V. As can also be seen in FIG. 1, a secondary compaction roller 11 is provided. This secondary compaction roller is an idle roller, very similar to primary compaction roller 5. This secondary compaction roller 11 provides an additional compacting force F2 with a determined offset distance d versus the force F1 exerted by primary compaction roller 5. Either or both of the primary and secondary compaction rollers may be embodied as a compliant compaction roller, i.e a compaction roller which may somewhat deform to assume the shape of the part against which it is pressed in order to ensure an even compaction force against an irregular surface.

The roller 11 compacting force is typically provided by a set of pneumatic actuators 13. Although not shown, suitable control means may be employed for controlling the amount of force applied by actuators 13. Further, other forms of actuators may be utilized, e.g. hydraulic, electric, etc.

Interposed between primary compaction roller 5 and secondary compaction roller 11, there is at least one secondary heating module 7, for example an IR heater, providing heat to the zone 10 thus enhancing the tackiness of the tows 4. It should be noted that multiple heating modules, e.g. IR heaters, could be situated in this region between rollers 5, 11. Further, secondary compaction arrangement 22 may not necessarily include at least one secondary heating module 7 and only include secondary compaction roller 11. Yet further, an IR heater is only one example of a heating module contemplated by the teachings herein. Indeed, other forms of heating modules could be used, e.g. forced air heaters, etc.

It is important to observe that the effect of the heat provided by the secondary heater cannot be considered equivalent to a power increase of the main heater(s) 6a and 6b because there are limitations on the maximum instantaneous temperature on the tows and consequently the main heater power has to be confined within determined limits. When the feed rates are increased, due to said limits, the contribution of at least one primary heating module to the tows tackiness may not be sufficient, particularly for BMI matrix materials, to sustain higher feed rates without showing lay-up quality problems due to insufficient bonding. As such, while not a mandatory requirement, the at least one secondary heating module advantageously aids in achieving higher feed rates.

The combined effect of post-heating the zone 9 by means of secondary heater 7 and the post-pressing of the tows 4 by means of the secondary compaction roller 11, is very effective in securing a proper quality of the lay-up of tows 4 in the zone 8 and thereafter even with BMI matrix materials, with a high quality consistency even at feed rates heretofore not possible when utilizing BMI matrix materials. In preliminary testing, the applicant has achieved twice the conventional feed rates for BMI matrix materials by utilizing the secondary compaction arrangement described herein.

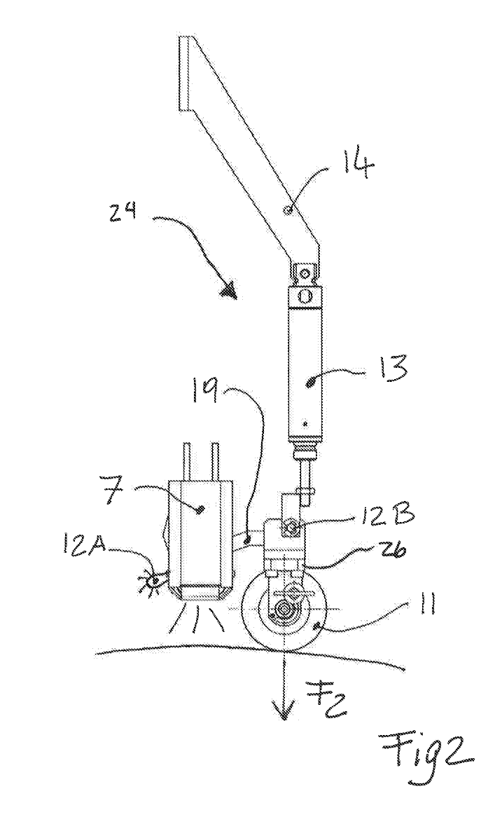

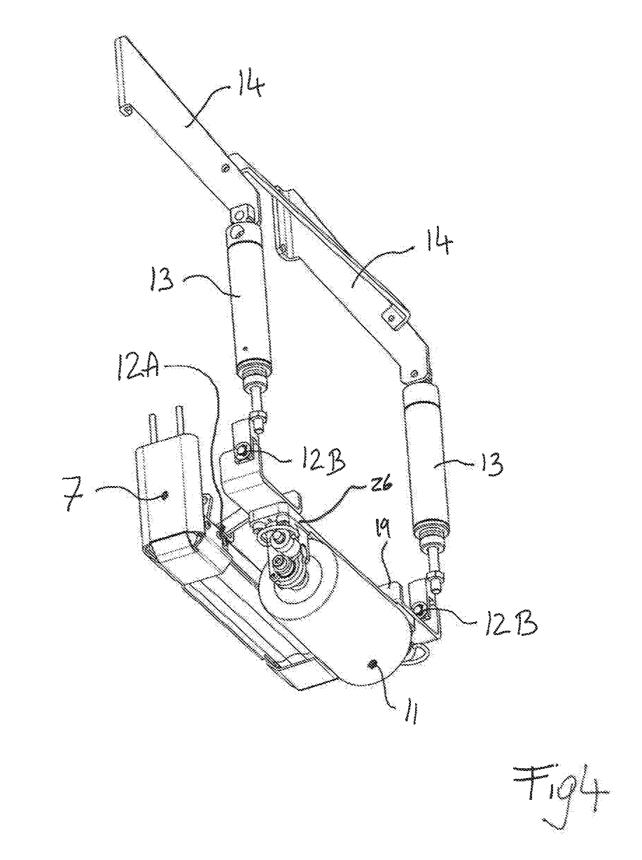

FIG. 2 shows a side view of the above-introduced secondary compaction arrangement 22 which comprises a support frame 24. Support frame 24 comprises a base member 14, a pair of actuating members in the form of pneumatic actuators 13 mounted to base member at first ends thereof, and a mounting member 19 mounted to second ends of pneumatic actuators 13 opposite the first ends thereof (see mounting location 12B). The at least one secondary heating module is embodied as an IR heater 7 and is mounted to mounting member 19 generally at mounting point 12A as shown in FIG. 4. A roller base 26 is also mounted to mounted member 19. Secondary compaction roller 11 is rotatably mounted to roller base 26.

Advantageously, the device can still be active even in very limited clearance in zones where the tows cut edge is unavoidably very close to the edge of the mold. In these areas the multi-axes Head positioner will have to apply a dedicated path strategy wherein after primary compaction roller 5 reaches said tow edge, the entire head 20 is rotated and or lifted, while proceeding along the direction D of FIG. 1, in order to lift the primary compaction roller 5, yet allowing secondary compaction roller 11 to complete the post-pressing the tows up to said edge.

Having described the basic structure of an embodiment of the invention here, a description of an exemplary embodiment of a method of laying up one or more tows using the fiber placement head 20 and secondary compaction arrangement 22 will now be provided. Referring principally to FIGS. 1 and 3, in a typical operation, fiber placement head 20 is moved in a lay-up direction D. At least one primary heating module, in this case heaters 6a and 6b pre-heat a working surface 3. Downstream from this primary heating module, one or more tows 4 are applied to working surface 3. Immediately upon application, tows 4 are compacted by primary compaction roller 5 downstream from heaters 6a and 6b. After being compacted, and in embodiments which incorporate a secondary heating module 7 downstream from primary compaction roller 5, the tows 4 are then heated again. It will be recognized that in other embodiments not utilizing a secondary heating module 7, no additional heating is provided in this region. Thereafter, secondary compaction roller 11 applies a subsequent compaction force to tows 4 downstream from primary compaction roller 5. Although not required, an additional inspection step may also be undertaken using an inspection device 17 downstream from secondary compaction roller 11.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A fiber placement head, the fiber placement head movable in a lay-up direction to deposit one or more tows on a working surface, the fiber placement head comprising:
a frame;
a primary compaction roller mounted to the frame and configured to apply a downward compaction force against the one or more tows upon being deposited on the working surface;
at least one primary heating module mounted to the frame upstream from the primary compaction roller relative to the lay-up direction;
a secondary compaction arrangement mounted to the frame downstream from the primary compaction roller relative to the lay-up direction.

2. The fiber placement head of claim 1, wherein the secondary compaction arrangement comprises:
a support frame mounted to the frame of the fiber placement head; and
a secondary compaction roller mounted to the support frame and configured to apply a downward force against the one or more tows subsequent to compaction by the primary compaction roller.

3. The fiber placement head of claim 2, wherein the secondary compaction arrangement further comprises at least one secondary heating module mounted to the support frame.

4. The fiber placement head of claim 1, wherein at least one of the primary compaction roller and secondary compaction roller is a compliant compaction roller.

5. The fiber placement head of claim 1, wherein the at least one primary heating module includes multiple heating modules.

6. The fiber placement head of claim 1, wherein the at least one primary heating module is an IR heater.

7. The fiber placement head of claim 3, wherein the at least one secondary heating module is an IR heater.

8. The fiber placement head of claim 3, wherein the at least one secondary heating module is interposed between the primary compaction roller and the secondary compaction roller relative to the lay-up direction.

9. A secondary compaction arrangement for a fiber placement head, the fiber placement head movable in a lay-up direction to deposit one or more tows on a working surface and comprising a frame, a primary compaction roller mounted to the frame, and at least one primary heating module mounted to the frame, the secondary compaction arrangement comprising:
a support frame configured for mounting to the frame of the fiber placement head; and
a secondary compaction roller mounted to the support frame and configured to apply a downward force against the one or more tows, the secondary compaction roller being arranged downstream from the primary compaction roller relative to the lay-up direction.

10. The secondary compaction arrangement of claim 9, further comprising at least one secondary heating module mounted to the support frame, the at least one secondary heating module arranged upstream from the secondary compaction roller relative to the lay-up direction.

11. The secondary compaction arrangement of claim 10, wherein the support frame includes a base member and a pair of intermediate members mounted in parallel relative to one another to the base member, wherein the base member comprises first end regions configured for mounting the support frame to the frame of the fiber placement head.

12. The secondary compaction arrangement of claim 10, wherein each intermediate member comprises an actuating member and wherein the secondary compaction arrangement further comprises a mounting member, the mounting member mounted to the actuating members.

13. The secondary compaction arrangement of claim 12, wherein each actuating member is connected to the base member at a respective first end of each actuating member, and wherein the mounting member is mounted at a respective second end of each actuating member which is opposite the first end.

14. The secondary compaction arrangement of claim 13, further comprising a roller base mounted to the mounting member, said secondary compaction roller being rotatably mounted to said roller base.

15. The secondary compaction arrangement of claim 14, wherein the at least one secondary heater is mounted to the mounting member.

16. The secondary compaction arrangement of claim 9, wherein the secondary compaction roller is a compliant compaction roller.

17. A method for laying up one or more tows on a working surface using a fiber placement head, the method comprising:
preheating a working surface using at least one primary heating module;
depositing one or more tows on the preheated working surface;
compacting the one or more tows using a primary compaction roller; and
compacting the one or more tows again using a secondary compaction roller after being compacted by the first compaction roller.

18. The method of claim 17, further comprising heating, with at least one secondary heating module, the one or more tows after being compacted by the first compaction roller.

19. The method of claim 18, wherein compacting the one or more tows again using the secondary compaction roller after being heated by the at least one secondary heater includes compacting said tows using a compliant compaction roller.

20. The method of claim 18, wherein heating the one or more tows after being compacted by the primary compaction roller using at least one secondary heating module includes using an IR heater as the at least one secondary heating module.
